(19) United States
(12) Patent Application Publication
(10) Pub. No.: US 2024/0079899 A1
(43) Pub. Date: Mar. 7, 2024

(54) OPTIMIZED CHARGE LIMIT

(71) Applicant: Apple Inc., Cupertino, CA (US)

(72) Inventors: Kartik R. Venkatraman, San Francisco, CA (US); Manish Chandra Reddy Ravula, Saratoga, CA (US); Felix T. Tristram, Santa Clara, CA (US)

(21) Appl. No.: 18/162,167

(22) Filed: Jan. 31, 2023

Related U.S. Application Data
(60) Provisional application No. 63/374,662, filed on Sep. 6, 2022.

(51) Int. Cl. H02J 7/00

(52) U.S. Cl. CPC H02J 7/007182; H02J 7/0048

(57) ABSTRACT

An electronic device can include a power system including a battery and one or more processors programmed to: detect that the electronic device has been connected to a power source, predict using prior usage data of the electronic device whether battery usage between an expected time of disconnection from the power source and a next expected time of connection to the power source exceeds a threshold, and if the predicted battery usage between an expected time of disconnection from the power source and a next expected time of connection to the power source does not exceed the threshold, charge the battery to a state of charge less than the full state of charge of the battery.

### CROSS-REFERENCE TO RELATED APPLICATIONS

This application claims priority to U.S. Application No. 63/374,662, entitled “OPTIMIZED CHARGE LIMIT,” filed Sep. 6, 2022, which is hereby incorporated by reference in its entirety for all purposes.

### BACKGROUND

Users may employ a wide variety of electronic devices that rely on battery power. Users typically want these batteries to have sufficient capacity and charge to power usage of the device between charging opportunities. Thus, such devices may be plugged in to an external power source, such as AC mains power, whenever possible. However, at least some battery technologies may exhibit increased wear when charged to high states of charge relative to their full charge capacity. Thus, battery wear may be reduced, and battery capacity may be preserved by reducing the amount of time that the battery spends at high states of charge.

### SUMMARY

In some applications, a device can reduce the amount of time that its battery spends at a high state of charge relative to its full charge capacity by an optimized battery charging routine that delays charging the battery to its full state of charge until a time that is just before it is expected to be disconnected from the power source. However, even in such cases, if the user will need less than substantially all of the battery's full charge capacity, the battery could be charged to a lower state of charge that is less than the full capacity of the battery but is still sufficient to accommodate the intended usage before the next time the battery will be recharged.

An electronic device can include a power system including a battery and one or more processors programmed to: detect that the electronic device has been connected to a power source, predict using prior usage data of the electronic device whether battery usage between an expected time of disconnection from the power source and a next expected time of connection to the power source exceeds a threshold, and if the predicted battery usage between an expected time of disconnection from the power source and a next expected time of connection to the power source does not exceed the threshold, charge the battery to a state of charge less than the full state of charge of the battery.

The one or more processors can be further programmed to predict, using prior usage data of the electronic device, whether battery usage between an expected time of disconnection from the power source and a next expected time of connection to the power source exceeds a threshold using a machine learning model that analyzes the prior usage data. The prior usage data can include a time series of prior charging and discharging intervals. The prior usage data can further include at least one of: user calendar data, alarms, passes for events associated with a mobile wallet, or data extracted from emails. The state of charge less than the full state of charge of the battery can be selected to reduce wear on the battery caused by time at high states of charge. The one or more processors can be further programmed to dynamically select the state of charge less than the full state of charge based on the predicted battery usage between an expected time of disconnection from the power source and a next expected time of connection to the power source.

The one or more processors can be further programmed to predict whether a long charge event is expected. If a long charge event is not expected, the one or more processors can be further programmed to immediately charge the battery to a full state of charge. Alternatively, if a long charge event is expected, the one or more processors can be further programmed to delay charging of the battery to a full state of charge until a time prior to an expected disconnection time.

The one or more processors can be programmed to delay charging of the battery to a full state of charge by reducing the rate at which the battery charges. The one or more processors can be programmed to delay charging of the battery to a full state of charge by temporarily pausing battery charging.

The electronic device can further include a display. The one or more processors can be further programmed to communicate information about at least one of the time prior to an expected disconnection time or the state of charge less than the full state of charge of the battery to a user via the display. The electronic device can further include an input device. The one or more processors can be further programmed to receive user input regarding at least one of the time prior to an expected disconnection time or the state of charge less than the full state of charge of the battery from the user via the input device.

A method of operating an electronic device, performed by a processor of the electronic device, can include detecting that the electronic device has been connected to a power source; predicting, using prior usage data of the electronic device, whether battery usage between an expected time of disconnection from the power source and a next expected time of connection to the power source exceeds a threshold; and if the predicted battery usage between an expected time of disconnection from the power source and a next expected time of connection to the power source does not exceed the threshold, charging a battery of the electronic device to a state of charge less than the full state of charge of the battery.

Predicting, using prior usage data of the electronic device, whether battery usage between an expected time of disconnection from the power source and a next expected time of connection to the power source exceeds a threshold can include using a machine learning model to analyze the prior usage data. The prior usage data can include a time series of prior charging and discharging intervals. The prior usage data can further include at least one of: user calendar data, alarms, passes for events associated with a mobile wallet, or data extracted from emails. The state of charge less than the full state of charge of the battery can be selected to reduce wear on the battery caused by time at high states of charge.

The method can further include dynamically selecting the state of charge less than the full state of charge based on the predicted battery usage between an expected time of disconnection from the power source and a next expected time of connection to the power source. The method can further include communicating information about the state of charge less than the full state of charge of the battery to a user via a display of the electronic device. The method can further include receiving user input regarding the state of charge less than the full state of charge of the battery from the user via an input device of the electronic device.

### BRIEF DESCRIPTION OF THE DRAWINGS

FIG. 1 illustrates a block diagram of an electronic device.

FIG. 2 illustrates an optimized battery charging routine for an electronic device.

FIG. 3 illustrates a flowchart of an optimized charging routine.

FIG. 4 illustrates a flowchart of an optimized charging routine with dynamic end of charge also called an optimized charge limit.

FIG. 5 illustrates a block diagram of an optimized charging routine with dynamic end of charge or optimized charging limits.

FIG. 6 illustrates an electronic device that communicates parameters of an optimized battery charging routine to a user.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a drawing, refers to the same element throughout the several drawings, though it may not be repeated in every drawing. The drawings are not to scale unless otherwise indicated, and the proportions of certain parts may be exaggerated to better illustrate details and features of the present disclosure.

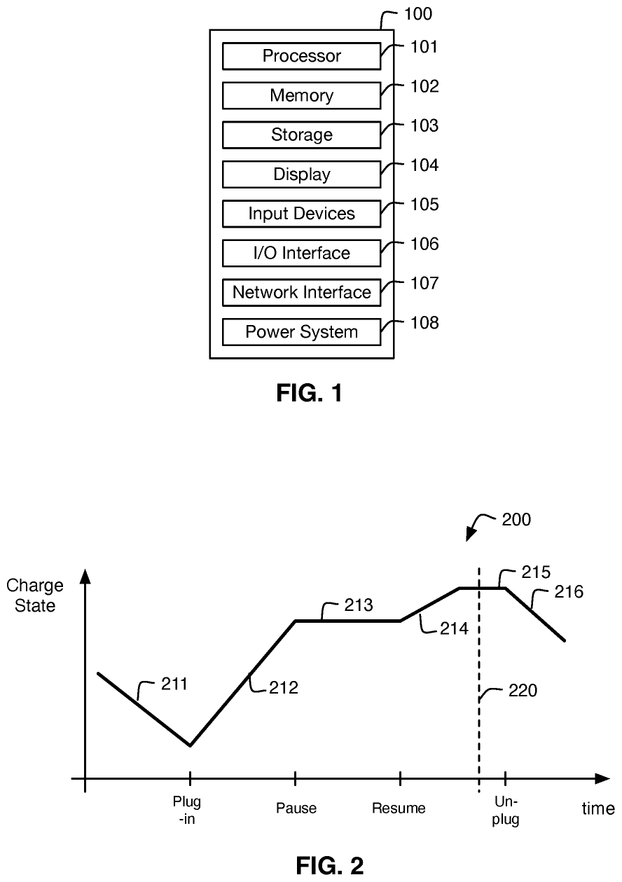

FIG. 1 is a block diagram of an electronic device 100, according to embodiments of the present disclosure. The electronic device 100 may include, among other things, one or more processors 101 (collectively referred to herein as a single processor for convenience, which may be implemented in any suitable form of processing circuitry), memory 102, nonvolatile storage 103, a display 104, input devices 105, an input/output (I/O) interface 106, a network interface 107, and a power system 108. The various functional blocks shown in FIG. 1 may include hardware elements (including circuitry), software elements (including machine-executable instructions), or a combination of both hardware and software elements (which may be referred to as logic). The processor 101, memory 102, the nonvolatile storage 103, the display 104, the input devices 105, the input/output (I/O) interface 106, the network interface 107, and/or the power system 108 may each be communicatively coupled directly or indirectly (e.g., through or via another component, a communication bus, a network, etc.) to one another to transmit and/or receive data amongst one another. It should be noted that FIG. 1 is merely one example of a particular implementation and is intended to illustrate the types of components that may be present in the electronic device 100.

By way of example, the electronic device 100 may include any suitable computing device, including a desktop or laptop/notebook computer (such as a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (such as an iPhone® available from Apple Inc. of Cupertino, California), a tablet computer (such as an iPad® available from Apple Inc. of Cupertino, California), a wearable electronic device (such as an Apple Watch® by Apple Inc. of Cupertino, California), and other similar devices.

Processor 101 and other related items in FIG. 1 may be embodied wholly hardware or by hardware programmed to execute suitable software instructions. Furthermore, the processor 101 and other related items in FIG. 1 may be a single contained processing module or may be incorporated wholly or partially within any of the other elements within the electronic device 100. Processor 101 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. Processor 101 may include one or more application processors, one or more baseband processors, or both, and perform the various functions described herein.

In the electronic device 100 of FIG. 1, processor 101 may be operably coupled with a memory 102 and a nonvolatile storage 103 to perform various algorithms. Such programs or instructions executed by processor 101 may be stored in any suitable article of manufacture that includes one or more tangible, computer-readable media. The tangible, computer-readable media may include the memory 102 and/or the nonvolatile storage 103, individually or collectively, to store the instructions or routines. The memory 102 and the nonvolatile storage 103 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by processor 101 to enable the electronic device 100 to provide various functionalities.

In certain embodiments, the display 104 may facilitate users to view images generated on the electronic device 100. In some embodiments, the display 104 may include a touch screen, which may facilitate user interaction with a user interface of the electronic device 100. Furthermore, it should be appreciated that, in some embodiments, the display 104 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input devices 105 of the electronic device 100 may enable a user to interact with the electronic device 100 (e.g., pressing a button to increase or decrease a volume level). The I/O interface 106 may enable electronic device 100 to interface with various other electronic devices, as may the network interface 107. In some embodiments, the I/O interface 106 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 107 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 107 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 107 of the electronic device 100 may allow communication over the aforementioned networks (e.g., 5G, Wi-Fi, LTE-LAA, and so forth).

The network interface 107 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power system 108 of the electronic device 100 may include any suitable source of power, such as a rechargeable battery (e.g., a lithium ion or lithium polymer (Li-poly) battery) and/or a power converter, including a DC/DC power converter, an AC/DC power converter, a power adapter (which may be external), etc.

FIG. 2 illustrates an optimized battery charging routine for an electronic device. More specifically, FIG. 2 illustrates a plot 200 of battery state of charge on the vertical axis versus time on the horizontal axis. Various events in the charging sequence are identified as times on the time axis. For example, prior to the device being plugged in to an external power source (such as mains power, an external battery pack, a car accessory adapter, etc.), the battery may be discharging as indicated by curve segment 211. After the device is plugged in to the external power source, the battery can begin charging as indicated by curve segment 212. Upon being plugged in to the external power source, the device can determine an estimated disconnect time 220 at which it expects to be disconnected from the external power source, which can be used to intelligently adapt the charging sequence as described in greater detail below.

The determination of estimated disconnect time 220 can be made in various ways based on sensor inputs (e.g., time of day, location, etc.) and a machine learning model or other program structure that accounts for prior activity or otherwise infers a likely disconnect time. For example, if a user typically plugs in a device at home at around 10 pm and unplugs it around 6 am, the device can infer that—if it is plugged in at around 10 pm at the user's home location—it will remain on the charger until about 6 am and can thus adapt the charging sequence accordingly. The same would be true if a user plugs in at the user's work location around 8 am and unplugs around 12 pm, which could allow the system to infer that the user is typically at his desk at this time. The inferences can be based on inputs other than time and location. For example, if a user plugs in and the device can detect that it is moving at a relatively high rate of speed, the device might infer that it is in an automobile. Depending on the particular implementation of the machine learning model or other program structure, more or less detailed inferences may be derived. In any case, the inference may be used to modify the charging sequence as follows.

In the first example of the preceding paragraph, in which the device infers that it is at the user's home location and has been plugged in at around 10 pm, the device can assume that it will remain connected to mains power until about 6 am. Thus, the device does not need to charge at the maximum rate (represented by the slope of curve segment 212) to reach full charge as soon as possible. In fact, it may be desirable to slow the rate of charging and/or pause charging for a time period, depicted by curve segment 213 to delay reaching full charge of the battery. For example, a battery's useful life (i.e., battery health or number of charge cycles over which substantially full capacity can be maintained) may be extended by reducing the amount of time that the battery spends at full charge. Thus, in the optimized battery charging example of FIG. 2, battery charging may be paused during interval 213.

Estimated disconnect time 220 may be further used by the device to resume charging at a time selected to ensure that the battery reaches a fully charged state (represented by charge level/curve segment 215) prior to estimated disconnect time 220. This resumed charging is represented by curve segment 214. This charging segment may take place at a reduced rate, for example because the battery is closer to full charge, as indicated by the reduced slope of resumed charging segment 214 versus original charging segment 212. In any case, the machine learning model or other program structure that controls the optimized battery charging sequence may account for the expected charging rate and estimated disconnect time to ensure that the battery is fully charged prior to the user disconnecting the device from the external power source. This may be accomplished by selecting an estimated disconnection time that is before the likely or typical disconnect time and/or by ensuring that the battery is fully charged before estimated disconnect time 220. Once the user disconnects the device from the external power source, the battery may begin discharging, as illustrated by curve segment 216.

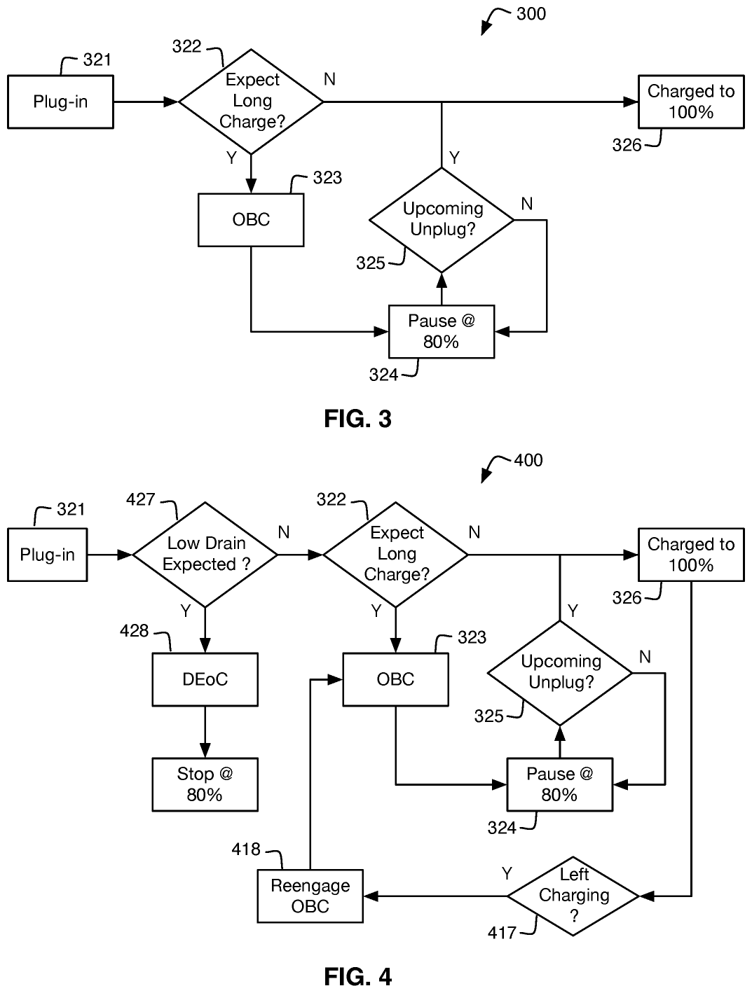

The optimized battery charging technique described with respect to FIG. 2 is “optimized” in the sense that it may improve battery health by reducing the amount of time that the battery spends at a full charge state. FIG. 3 illustrates a flowchart 300 further depicting such an optimized charging routine. The various processes described in flowchart 300 may be performed by a processor of the electronic device 100, by a microcontroller or other control circuitry associated with power system 108, or by any other appropriate component of device 100. In some cases, different parts of the process may be performed by different components of device 100. Beginning at block 321, the device can detect that it has been plugged in to an external power source.

Once the plug-in event is detected, the optimized charging system can determine whether a “long charge” is expected (block 322). In this sense, a long charge means a charging event that would be more than long enough to bring the battery to a full state of charge. As one example, if a user regularly plugs his device in around 10 pm when located at home and it is typically unplugged around 6 am, being plugged in at 10 pm when located at home can trigger detection of a long charge event. Similarly, if a user regularly plugs in his device around 8 am when arriving at the office and unplugs around 12 noon when leaving for lunch, this may also be interpreted as an expected long charge event. However, if the device is plugged in at a time or location that is not typical, the device may not have an expectation as to how long the charging event will last. The device can be provided with a wide variety of programming, criteria, algorithms, etc. to determine whether an event is expected to be a long charge event. This can include the use of machine learning models, heuristics, and other data processing techniques to analyze historical data (such as previous charging and discharging events), present sensor data (such as state of charge, location, etc.), and external data (such as information from a user's calendar relating to upcoming events and their associated locations).

If a long charge event is not expected, then the device can proceed to charge the battery to 100% (block 326), which can provide an expected user experience. Alternatively, if a long charge event is detected, then the optimized battery charging routine (block 323) can be triggered. The basic idea of the optimized battery charging routine is as described above. Namely, the battery is charged to some threshold short of full charge, e.g., 80% (block 324). This threshold need not be 80% and could be any suitable value. However, minimizing the amount of time that the battery spends above such a threshold can reduce wear or aging of the battery that leads to diminished battery capacity. Then, in block 325, the device can determine whether an unplug event is upcoming. In this sense, the event is upcoming in the sense that the remaining time before the unplug event is roughly equal to the amount of time required to bring the battery from the 80% state (or other pause threshold) to full charge (e.g., 100%). If an upcoming unplug event is not expected, then the system can hold the battery at the 80% state of charge, or other threshold (block 324). Otherwise, if an upcoming unplug is expected, then the system can complete charging the battery to 100%.

As can be inferred from the preceding description, part of optimized battery charging routine as performed by block 322 and/or block 323 can be to determine when the device is expected to be unplugged. This can be determined using various algorithms, models, data analysis, etc. as discussed above. In one example embodiment, upon detecting a plug-in, the device can estimate an unplug or disconnect time. Then, the OBC routine 323, can specify a time that is before the estimated unplug time to be the target time to complete battery charging. For example, if a user typically plugs in at 10 pm and unplugs at 6 am, then 5 am may be used as the target time to complete battery charging, to ensure that the battery is fully charged when needed by a user. Then, if it would take 1 hour to bring the battery from 80% charge to 100% charge, the upcoming unplug detection of block 325 can be set to occur at 4 am. These times, time periods, and threshold states of charge are examples only, and other values could be used as appropriate.

An optimized battery charging routine as described above can improve battery health and longevity by reducing the time that the battery spends at high states of charge. However, using such an approach, the battery will still be at a high state of charge for a significant period of time. For example, using the times discussed above, the battery may be at a high state of charge (e.g., above 80%) from 4 am (when charging to 100% resumes) until sometime mid-morning when the user's usage of the phone as brought the state of charge back below 80% (or other appropriate threshold). However, if the user's usage pattern between plug-in events does not use all or an appreciable fraction of the entire full charge capacity of the battery, then this several hours above the charge threshold may still place unnecessary wear on the battery.

FIG. 4 illustrates a flowchart 400 of an optimized charging routine with dynamic end of charge also called an optimized charge limit. As with the optimized battery charging routine discussed above with respect to FIG. 3, the various pieces of the routine can be performed by any suitable processor, microcontroller, or other control circuitry of device 100. The optimized charging routine of FIG. 4 differs from that of FIG. 3 at least in that, upon detecting a plug-in event (block 321), the system can determine whether the user's expected battery drain before next plugging in is expected to be low (block 427). In other words, the system can determine whether or not the user will use all or a substantial fraction of the battery's capacity before plugging again. This determination may be made in a variety of ways but can be thought of generally as relying on analysis of past usage data. This past usage data can include a time series of previous battery charge and discharge cycles. This data can be combined with related data such as time of day that such charge and discharge cycles start and end, days of the week associated with the charging cycles, location data associated with the charge and discharge cycles, and any other data relating to the user's device usage patterns that can be suitably correlated with the battery charge and discharge patterns to make a reliable prediction about the amount of charge that the user needs to have sufficient energy stored in the battery for the device to last until the next plug-in event.

Determining whether the user's expected battery drain before a next plug-in event is low can use a variety of data analysis algorithms, types, heuristics, etc. As one example, a machine learning model can be configured to make a prediction, based on prior usage data, whether the user's discharge before a next plug-in event is expected to be greater than a threshold. An alternative framing of the question is whether the user's predicted usage before an expected next plug-in event would cause the battery state of charge to go below some minimal threshold. As one example, it may be desirable to keep the battery state of charge above 10%, 20%, or some other suitable threshold, both to allow for unanticipated usage and to prevent user concern associated with a low state of charge. If analysis of prior usage data suggests an expected battery usage of 50%, for example, before the next expected plug-in event, then it may not be necessary to charge to 100% before the next unplug event to meet the user's battery needs. On the other hand, if the expected usage before the next plug-in event is 80% or more of the battery's capacity before the next plug-in event, then it may be preferable to charge the battery to full capacity (for example in using an optimized battery charging routine as described above) to ensure that the user has sufficient charge available. The 50% and 80% expected usages described above are provided as examples, and other suitable thresholds could be used as appropriate.

In any case, if a low drain is expected before the next charging cycle, then the dynamic end of charge process 428 can be invoked. In the dynamic end of charge process, a less than 100% state of charge may be selected as the endpoint of the charging process. In some cases this could be 80%, but could be any other suitable value. Likewise, in some applications, the end of charge threshold could be a fixed value, i.e., if the low drain expected state is triggered, then the battery is always charged to a fixed state of charge less than 100%. In other applications, the dynamic end of charge threshold could vary based on the actual expected drain before the next plugin. For example, if a 20% low discharge margin is selected, and the user is expected to use 40% of the battery's capacity before the next plug-in, then the dynamic end of charge process 428 could charge the battery to 60%. Alternatively, with a 10% low discharge margin and a 60% expected discharge before the next plug-in event, a 70% state of charge could be chosen as the dynamic end of charge threshold. In other words, the dynamic end of charge threshold can be fixed (e.g., 80% in the first example described above) or could vary based on the expected discharge. This variable dynamic end of charge threshold could also be affected by other conditions.

Alternatively, if a low drain before the next plug-in event is not expected (i.e., higher drain is expected), then the optimized battery charging system represented by flowchart 400 can employ an optimized battery charging routine similar to that discussed above with respect to FIG. 3 that controls the timing at which the battery reaches full charge to reduce the amount of time that the battery spends above a threshold corresponding to a high state of charge (e.g., 80%). These portions of the algorithm of FIG. 4 are the same as discussed above with respect to FIG. 3, and thus the details of this process are not repeated here.

One other addition to the optimized charging routine depicted by flowchart 400 relates to a situation in which the device remains connected to the charger after reaching 100% state of charge (as depicted in block 417). In this case, the system may stop battery charging, and allow the battery to begin discharging. The device may also reengage optimized battery charging (block 418), in which case the system can determine a next expected unplug time, and operate the charging system to reach full charge prior to the next expected unplug time.

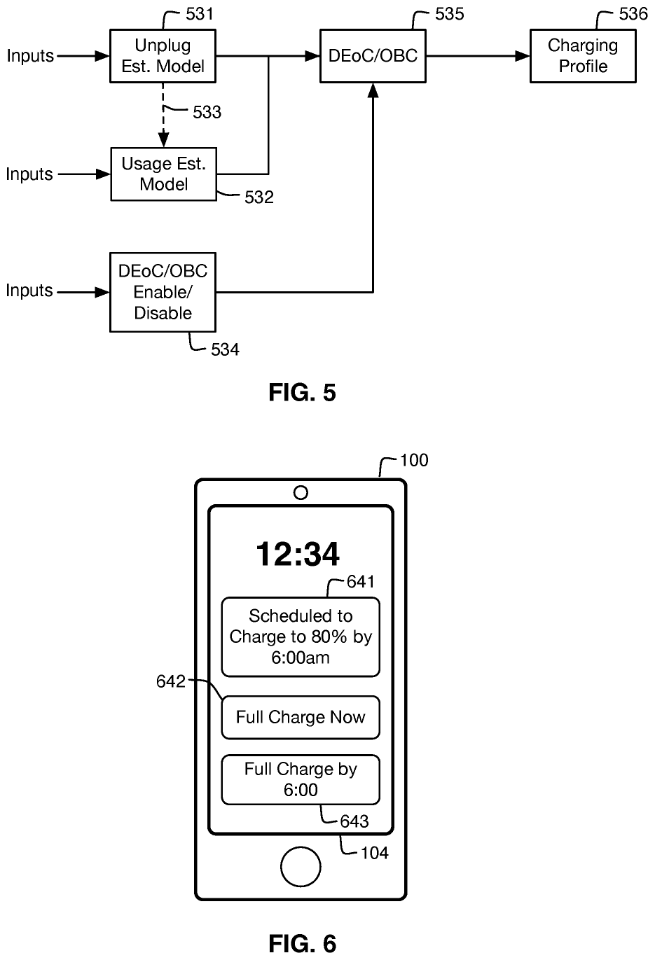

FIG. 5 illustrates a block diagram of various processing elements for an optimized charging routine with dynamic end of charge or optimized charging limits. Block 531 can be an unplug estimation model. This can be implemented by programming one or more processors of device 100, including a processor of processor complex 101 or a microcontroller or other suitable circuitry associated with power system 108 to estimate a disconnection time when the device is plugged into an external power source. In some embodiments, unplug estimation model 531 can be a machine learning model that looks at prior usage patterns to estimate a predicted unplug time.

Unplug estimation model 531 can take a variety of inputs. These inputs can include prior plug in and unplug times, which may be advantageously processed by a machine learning model. Additional parameters can include locations, times of day, days of week, plugged-in durations, un-plugged durations, etc. associated with or derived from the plug and unplug times. The inputs can also include other usage data, including, without limitation, user calendar data, alarms, passes for events associated with a mobile wallet or similar application, data extracted from emails or other user data. As outlined below, privacy concerns may suggest limiting or not accessing some of this type of data, although steps may be taken to preserve user privacy in analyzing such data to predict an estimated. In any case, the predicted unplug or disconnect time can be provided to dynamic end of charge/optimized battery charge processor 535 (described in greater detail below), and optionally to usage estimation model 532 via path 533.

With continued reference to FIG. 5, block 532 can be a usage estimation model. As described above with reference to FIG. 4, this can be used to estimate the user's battery usage before a next plug-in event and/or predict whether the user's battery usage before the next plug-in event will be above or below a threshold. This prediction can be used to drive a dynamic end of charge limit as described above with reference to FIG. 4. Usage estimation model 532 can be implemented by programming one or more processors of device 100, including a processor of processor complex 101 or a microcontroller or other suitable circuitry associated with power system 108 to estimate device usage before the next time the device is expected to be plugged into an external power source. This next expected plug-in time can be computed by the usage estimation model 532 or can be received from unplug estimation model 531 via path 533. In some embodiments, usage estimation model 532 can be a machine learning model that looks at prior usage patterns to determine estimated usage before the next plug-in time.

Unplug estimation model 531 can take a variety of inputs. These inputs can include prior plug in and unplug times, which may be advantageously processed by a machine learning model. The inputs can further include usage data corresponding to device usage and/or battery discharge between the plug-in intervals. Additional parameters can include locations, times of day, days of week, plugged-in durations, un-plugged durations, etc. associated with or derived from the plug and unplug times. The inputs can also include other usage data, including, without limitation, user calendar data, alarms, passes for events associated with a mobile wallet or similar application, data extracted from emails or other user data, or other user activities. As outlined below, privacy concerns may suggest limiting or not accessing some of this type of data, although steps may be taken to preserve user privacy in analyzing such data to predict an estimated. In any case, the predicted usage before the next plug-in—or an indication whether such usage will be above or below an appropriately selected threshold—can be provided to dynamic end of charge/optimized battery charge processor 535 (described in greater detail below).

With continued reference to FIG. 5, block 534 can be dynamic end of charge/optimized battery charging enable/disable module. This module can be used to selectively enable or disable the dynamic end of charge system and/or the optimized battery charging system when selected inputs indicate that use of these systems may not be advantageous to the user. At a simplest level, enable/disable module 534 could be manually triggered by the user to disable the dynamic end of charge/optimized battery charging routines as described below with respect to FIG. 6. Thus, the inputs into enable/disable module 534 could be tied to a user interface element or element(s) allowing such user-driven action. Additionally or alternatively, these inputs could include access to any of a wide variety of data suggesting that charging should be expedited and that dynamic end of charge or optimized battery charging should not be used.

The additional inputs could include locations, times of day, days of week, plugged-in durations, un-plugged durations, etc. associated with or derived from the plug and unplug times. The inputs can also include other usage data, including, without limitation, user calendar data, alarms, passes for events associated with a mobile wallet or similar application, data extracted from emails or other user data, or other user activities. Different types of data may be more applicable to certain types of devices. For example, data indicating the timing of a user's workout may be more relevant to a user's watch, as smartwatch activity may increase during a workout. However, this data may not be as relevant to a smartphone or laptop. As another example, calendar entries indicating a location outside a user's office may be more relevant to a laptop or notebook computer, as it may be assumed that the computer will not be plugged-in during this time. In some cases, how frequently a user plugs in and/or how frequently a user places the device in a low power mode can be used as cues to infer a user's level of concern about battery level. These signals may also be used to enable or disable dynamic end of charge and/or optimized battery charging. As outlined below, privacy concerns may suggest limiting or not accessing some of this type of data, although steps may be taken to preserve user privacy in analyzing such data to predict an estimated.

In any case, enable/disable block 534 can include suitable programming to inhibit the dynamic end or charge and/or optimized battery charging routines as appropriate. One example of such a situation could be when a confidence level in the accuracy of a prediction of unplug time (by Unplug Estimation Model 531) or estimated usage (by Usage Estimation Model 534) falls below a threshold.

Each of the foregoing modules 531, 532, and 534 have been described as separate, but in at least some embodiments, two or more of these models could be combined into an integrated model. Additionally, although the estimation models 531 and 532 were described above in terms of machine learning models, other non-machine learning models could also be incorporated, either in conjunction with the machine learning models or as alternatives thereto. In any case, the outputs of the models predicting unplug time, usage before next plugin, and whether or not dynamic end of charge and/or optimized battery charging should be enabled or disabled may be provided to dynamic end of charge/optimized battery charging block 535. Dynamic end of charge/optimized battery charging block 535 can broadly correspond to optimized battery charging block 323 and dynamic end of charge block 428 discussed above with respect to FIGS. 3 and 4. Dynamic end of charge/optimized battery charging block 535 can be programmed or configured to generate a charging profile 536 based on the outputs of models 531, 532, and 534 as discussed above. Such a charging profile may, for example, correspond generally to the battery charging curve discussed above with respect to FIG. 2. Thus, the charging profile can include a selection of charging times, charging rates, charging targets, hold thresholds, and/or other parameters that allow the battery to be charged to an acceptable level by an appropriate time, while attempting to reduce the amount of time that the battery spends in a high state of charge.

FIG. 6 illustrates an electronic device 100 that communicates parameters of an optimized battery charging routine to a user. FIG. 6 illustrates electronic device 100 as a smartphone, but could in fact be any of a variety of electronic devices, such as a smart watch, tablet computer, notebook or laptop computer, etc. As one example, electronic device 100 could use a display 104 to present a message 641 to the user indicating a time at which charging is scheduled to be finished and the level to which the battery may be charged. The time at which charging is scheduled to be finished can be associated with an optimized battery charging routine as described above, and the level to which the battery is to be charged can be associated with a dynamic end of charge system as also described above. In some cases, electronic device 100 could present a control element 642, such as a UI button, that the user could use to bypass the optimized charging routine and the dynamic end of charge threshold to complete charging to a 100% state of charge as expeditiously as possible. In some cases, electronic device 100 could also present a control element 643, such as a UI button, that the user could use to bypass the dynamic end of charge routine (charging to a full state of charge), but allowing the optimized battery charging system to delay reaching full charge until shortly before a predicted unplug/disconnect time. In some embodiments, control elements 642 and 643 and message 641 could be part of the same UI element, such as a GUI message/button, etc. In other cases, one or more other output devices of electronic device 100 could be used to provide the indication to the user and one or more other input devices of electronic device 100 could be used to receive input from the user indicating that the user wishes to bypass the optimized charging setup and complete charging as expeditiously as possible.

As used at various points in this disclosure, machine learning may refer to algorithms, statistical models, and the like that computer systems (such as electronic device 100) can use to perform a specific task with or without using explicit instructions. For example, a machine learning process may generate a mathematical model based on a sample of data, known as “training data,” to make predictions or decisions without being explicitly programmed to perform the task. Depending on the inferences to be made, electronic device 100 (or a sub-system or associated device thereof) may implement different forms of machine learning. For example, in some embodiments (e.g., when particular known examples exist that correlate to future predictions or estimates that the machine learning engine may be tasked with generating), a machine learning engine may implement supervised machine learning. In supervised machine learning, a mathematical model of a set of data contains both inputs and desired outputs. This data is referred to as “training data” and may include a set of training examples. Each training example may have one or more inputs and a desired output, also known as a supervisory signal. In a mathematical model, each training example is represented by an array or vector, sometimes called a feature vector, and the training data is represented by a matrix. Through iterative optimization of an objective function, supervised learning algorithms may learn a function that may be used to predict an output associated with new inputs. An optimal function may allow the algorithm to correctly determine the output for inputs that were not a part of the training data. An algorithm that improves the accuracy of its outputs or predictions over time is said to have learned to perform that task.

Supervised learning algorithms may include classification and regression techniques. Classification algorithms may be used when the outputs are restricted to a limited set of values, and regression algorithms may be used when the outputs have a numerical value within a range. Similarity learning is an area of supervised machine learning closely related to regression and classification, but the goal is to learn from examples using a similarity function that measures how similar or related two objects are. Similarity learning has applications in ranking, recommendation systems, visual identity tracking, face verification, and speaker verification.

Additionally and/or alternatively, in some situations, it may be beneficial for the machine learning engine to utilize unsupervised learning (e.g., when particular output types are not known). Unsupervised learning algorithms take a set of data that contains only inputs, and find structure in the data, like grouping or clustering of data points. The algorithms, therefore, learn from test data that has not been labeled, classified, or categorized. Instead of responding to feedback, unsupervised learning algorithms identify commonalities in the data and react based on the presence or absence of such commonalities in each new piece of data.

That is, the machine learning engine may implement cluster analysis, which is the assignment of a set of observations into subsets (called clusters) so that observations within the same cluster are similar according to one or more predesignated criteria, while observations drawn from different clusters are dissimilar. Different clustering techniques make different assumptions on the structure of the data, often defined by some similarity metric and evaluated, for example, by internal compactness, or the similarity between members of the same cluster, and separation, the difference between clusters. In additional or alternative embodiments, the machine learning engine may implement other machine learning techniques, such as those based on estimated density and graph connectivity.

The foregoing describes exemplary embodiments of shifting certain tasks performed by an electronic device based on grid conditions associated with an external power source connected to the electronic device. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of electronic systems that are able to transmit certain information amongst other systems and devices. The present disclosure contemplates this passage of information improves the devices' functionality. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted and allow users to “opt in” or “opt out” of participation.

Risk can be minimized by limiting the collection of data and deleting data once it is no longer needed. In addition, and when applicable, data de-identification can be used to protect a user's privacy. For example, a device identifier may be partially masked to convey the power characteristics of the device without uniquely identifying the device. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. Robust encryption may also be utilized to reduce the likelihood that communications between devices are intercepted, spoofed, or otherwise subject to tampering.

1. An electronic device comprising:
a power system including a battery; and
one or more processors programmed to:
detect that the electronic device has been connected to a power source;
predict using prior usage data of the electronic device whether battery usage between an expected time of disconnection from the power source and a next expected time of connection to the power source exceeds a threshold; and
if the predicted battery usage between an expected time of disconnection from the power source and a next expected time of connection to the power source does not exceed the threshold, charge the battery to a state of charge less than the full state of charge of the battery.

2. The electronic device of claim 1 wherein the one or more processors are programmed to predict, using prior usage data of the electronic device, whether battery usage between an expected time of disconnection from the power source and a next expected time of connection to the power source exceeds a threshold using a machine learning model that analyzes the prior usage data.

3. The electronic device of claim 2 wherein the prior usage data includes a time series of prior charging and discharging intervals.

4. The electronic device of claim 3 wherein the prior usage data further comprises at least one of: user calendar data, alarms, passes for events associated with a mobile wallet, or data extracted from email s.

5. The electronic device of claim 1 wherein the state of charge less than the full state of charge of the battery is selected to reduce wear on the battery caused by time at high states of charge.

6. The electronic device of claim 1 wherein the one or more processors are further programmed to dynamically select the state of charge less than the full state of charge based on the predicted battery usage between an expected time of disconnection from the power source and a next expected time of connection to the power source.

7. The electronic device of claim 1 wherein the one or more processors are further programmed to:
predict whether a long charge event is expected; and
if a long charge event is not expected, immediately charge the battery to the full state of charge; or
if a long charge event is expected, delay charging of the battery to the full state of charge until a time prior to an expected disconnection time.

8. The electronic device of claim 1 wherein the one or more processors are programmed to delay charging of the battery to the full state of charge by reducing the rate at which the battery charges.

9. The electronic device of claim 1 wherein the one or more processors are programmed to delay charging of the battery to the full state of charge by temporarily pausing battery charging.

10. The electronic device of claim 6 further comprising a display, wherein the one or more processors are further programmed to communicate information about at least one of the time prior to an expected disconnection time or the state of charge less than the full state of charge of the battery to a user via the display.

11. The electronic device of claim 10 further comprising an input device, wherein the one or more processors are further programmed to receive user input regarding at least one of the time prior to an expected disconnection time or the state of charge less than the full state of charge of the battery from the user via the input device.

12. The electronic device of claim 1 further comprising a display, wherein the one or more processors are further programmed to communicate information about the state of charge less than the full state of charge of the battery to a user via the display.

13. The electronic device of claim 12 further comprising an input device, wherein the one or more processors are further programmed to receive user input regarding the state of charge less than the full state of charge of the battery from the user via the input device.

14. A method of operating an electronic device, the method performed by a processor of the electronic device and comprising:
detecting that the electronic device has been connected to a power source;
predicting, using prior usage data of the electronic device, whether battery usage between an expected time of disconnection from the power source and a next expected time of connection to the power source exceeds a threshold; and
if the predicted battery usage between an expected time of disconnection from the power source and a next expected time of connection to the power source does not exceed the threshold, charging a battery of the electronic device to a state of charge less than the full state of charge of the battery.

15. The method of claim 14 wherein predicting, using prior usage data of the electronic device, whether battery usage between an expected time of disconnection from the power source and a next expected time of connection to the power source exceeds a threshold comprises using a machine learning model to analyze the prior usage data.

16. The method of claim 15 wherein the prior usage data includes a time series of prior charging and discharging intervals.

17. The method of claim 16 wherein the prior usage data further comprises at least one of: user calendar data, alarms, passes for events associated with a mobile wallet, or data extracted from emails.

18. The method of claim 14 wherein the state of charge less than the full state of charge of the battery is selected to reduce wear on the battery caused by time at high states of charge.

19. The method of claim 14 further comprising dynamically selecting the state of charge less than the full state of charge based on the predicted battery usage between an expected time of disconnection from the power source and a next expected time of connection to the power source.

20. The method of claim 14 further comprising communicating information about the state of charge less than the full state of charge of the battery to a user via a display of the electronic device.

21. The method of claim 20 further comprising receiving user input regarding the state of charge less than the full state of charge of the battery from the user via an input device of the electronic device.
